(19) United States
(12) Patent Application Publication
(10) Pub. No.: US 2007/0274031 A1
(43) Pub. Date: Nov. 29, 2007

(54) Case coupling and reinforcing structure

(76) Inventor: Kuo An Chen, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/432,319

(22) Filed: May 12, 2006

(51) Int. Cl. G06F 1/16

(52) U.S. Cl. 361/683

(57) ABSTRACT

A case coupling and reinforcing structure is provided on an inner surface of a first and a second case of an apparatus. The first and the second case are primarily assembled and locked to each other using a plurality of screws. The case coupling and reinforcing structure includes a plurality of perpendicular rib reinforcements spaced along an inner side of a peripheral edge of the first case, and a plurality of cuts provided on a peripheral edge of the second case at positions corresponding to the rib reinforcements, such that the rib reinforcements are tightly received in and engaged with the cuts when the first and the second case are assembled to each other, giving the assembled cases a reinforced structural strength to enable a reduced number of screws being used and a reduced material thickness of the casing, and accordingly, reduced material and manufacturing costs of the casing.

### BACKGROUND OF THE INVENTION

1. Field of the Invention

The present invention relates to a case coupling and reinforcing structure, and more particularly to a case coupling and reinforcing structure for a casing of an electronic apparatus, a computer apparatus, or a peripheral thereof.

2. Description of the Prior Art

For the purpose of developing a lightweight and compact electronic apparatus, a computer apparatus, or a peripheral thereof, a casing made of a plastic material or a light metal material and consisting of an upper and a lower case is typically adopted for the apparatus. The upper and the lower case are normally assembled together by screws tightened along peripheral edges of the cases. When it is desired to further reinforce a structural strength of the casing, a most common way is to increase the number of screws used to tighten the upper and the lower case. This would increase the cost and complicate the fabrication of the casing. There are also other products that are provided with additional hooking means in an attempt to firmly hook the upper and lower cases together. Such hooking means are subject to breaking and would therefore cause difficulties in assembling and maintaining the cases.

Take a computer keyboard as an example. Please refer to FIG. 1 that is an exploded perspective view of a conventional computer keyboard having a casing formed from an upper and a lower case. Since there are many keys to be provided on the keyboard, the upper case of the casing of the keyboard must be formed with many key mounting openings. Since these key mounting openings inevitably reduce an overall structural strength of the casing, the material for forming the casing must have an increased thickness, and more screws are needed to lock the upper and the lower case together. That is, the conventional keyboard requires increased material and manufacturing costs.

It is therefore tried by the inventor to eliminate the problems in the conventional case assembling structure normally adopted in the casing of most electronic and computer apparatus or the peripherals thereof by developing a case coupling and reinforcing structure that effectively couples while reinforces the upper and lower cases of a casing without the need of increasing the material thickness of the casing or the number of screws for locking the cases together.

### SUMMARY OF THE INVENTION

A primary object of the present invention is to provide a case coupling and reinforcing structure that gives a casing of an apparatus a reinforced structural strength, so that the number of screws used to lock the casing and a material thickness of the casing may be reduced to lower the material and manufacturing costs of the casing.

To achieve the above and other objects, the case coupling and reinforcing structure according to an embodiment of the present invention is provided on a first and a second case that together form a casing of an apparatus. The first and the second case are primarily assembled and locked to each other using screws. The case coupling and reinforcing structure includes a plurality of rib reinforcements perpendicularly provided on an inner side of the first case, and a plurality of cuts provided on an inner side of the second case at positions corresponding to the rib reinforcements, such that the rib reinforcements are tightly received in and engaged with the cuts when the first and the second case are assembled to form the casing.

In a preferred embodiment of the present invention, the perpendicular rib reinforcements are spaced at an inner side of a peripheral edge of the first case, and the cuts are spaced on a peripheral edge of the second case.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view showing a conventional case assembling structure for a keyboard;

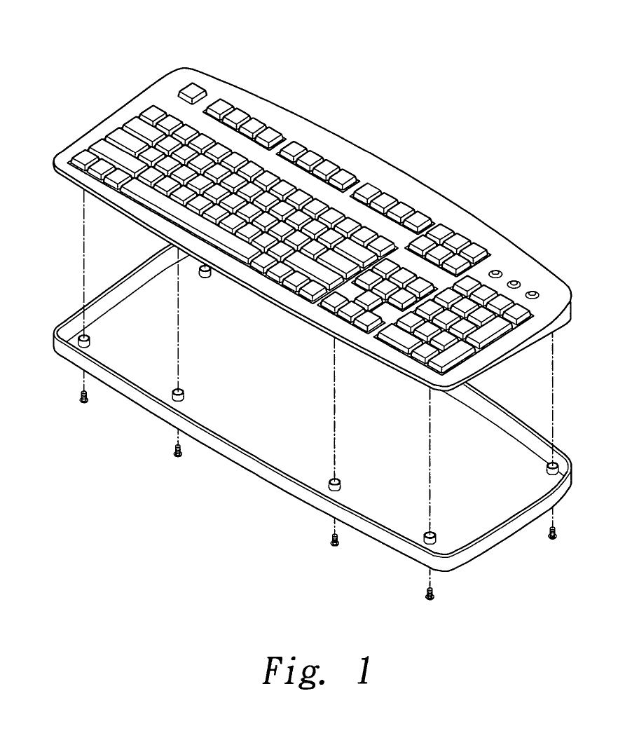

FIG. 2 is an exploded perspective view showing a case coupling and reinforcing structure according to an embodiment of the present invention being applied on a keyboard;

FIG. 3 is a fragmentary and enlarged view of FIG. 2; and

FIG. 4 is a fragmentary and enlarged sectional view of the keyboard of FIG. 2 in an assembled state.

### DETAILED DESCRIPTION OF THE PREFERRED EMBODIMENTS

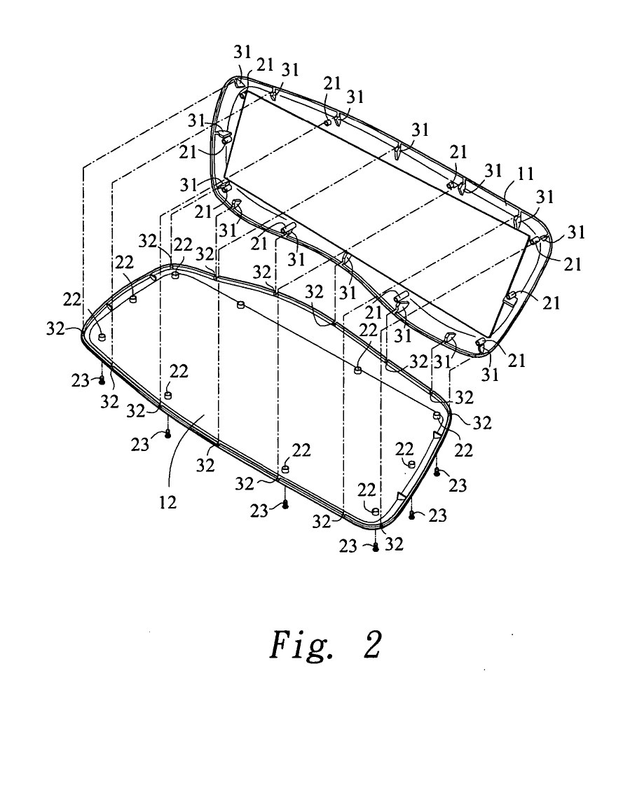

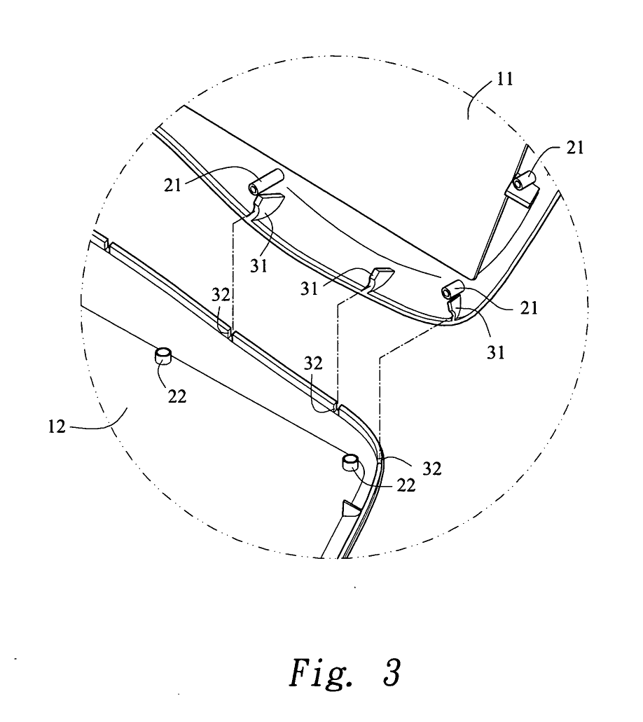

Please refer to FIG. 2 that is an exploded perspective view showing the case coupling and reinforcing structure according to an embodiment of the present invention is applied to join two cases that together form a casing of a keyboard, and to FIG. 3 that is a fragmentary and enlarged view of FIG. 2. As shown, the present invention is designed mainly to couple and reinforce two cases of a casing of an electronic apparatus, a computer apparatus, or a peripheral thereof. Generally, the cases of the electronic apparatus may be made of a plastic material, or a light metal material, such as an aluminum alloy, a tin-aluminum alloy, and a magnesium-aluminum alloy.

The following description of the present invention is based on an application thereof to a general plastic keyboard. As shown in FIG. 2, the keyboard has a casing including two cases, namely, a first case 11 and a second case 12 that are closed to each other. In the illustrated embodiment, the first case 11 and the second case 12 form an upper and a lower case, respectively, of the keyboard.

The first case 11 is provided on an inner surface near a peripheral edge thereof with a plurality of spaced screw sleeves 21, and the second case 12 is provided with a plurality of internally threaded holes 22 at positions corresponding to the screw sleeves 21, such that a plurality of screws 23 may be separately threaded through the screw holes 22 into the screw sleeves 21 to lock the second case 12 to the first case 11.

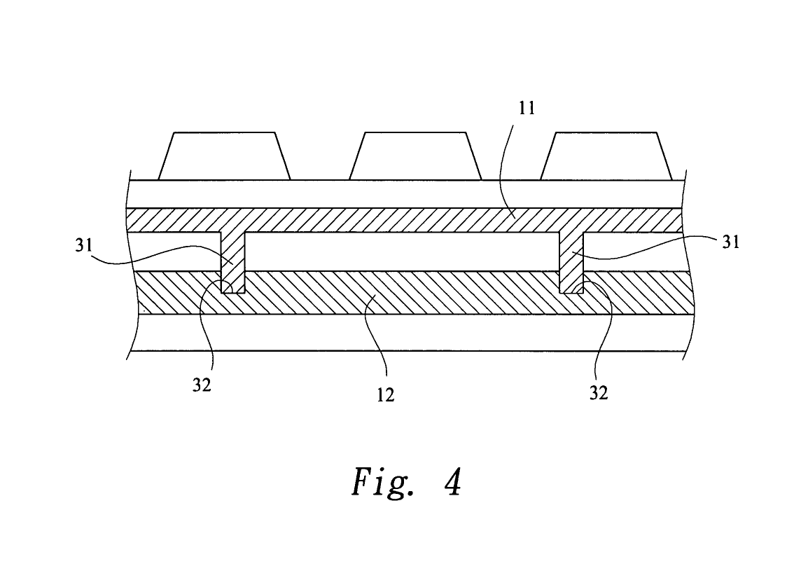

The first case 11 is further provided on the inner surface at predetermined positions with a plurality of spaced rib reinforcements 31, which are perpendicularly extended from the inner surface of the first case 11 by a predetermined length. And, the second case 12 is further provided on an inner surface with a plurality of spaced receiving cuts 32 at positions corresponding to the rib reinforcements 31, such that the perpendicular rib reinforcements 31 are separately tightly received in and engaged with the cuts 32 when the first case 11 is closed and assembled to the second case 12, as shown in FIG. 4. The engaged rib reinforcements 31 and cuts 32 function to stabilize and reinforce an overall structural strength of the casing of the keyboard assembled from the first and the second case 11, 12. In the present invention, the perpendicular rib reinforcement 31 may be differently shaped, such as in the form of a flat strip, a round column, a semi-circular column, a triangular column, a square column, or other irregularly shaped columns.

In the present invention, the perpendicular rib reinforcements 31 are preferably spaced at an inner side of a peripheral edge of the first case 31, and the cuts 32 are provided on a peripheral edge of the second case 12, so that the peripheral edges of the first and the second case 11, 12 are engaged with each another to achieve the object of reinforcing the overall structure of the keyboard. It is understood the rib reinforcements may also be provided on the second case 12 while the cuts are provided on the first case 11.

With the case coupling and reinforcing structure of the present invention, a casing assembled from two cases is not easily subjected to deformation or twisting, and does not produce friction noises when an external pressure is applied to the casing.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A case coupling and reinforcing structure provided on a casing of an electronic apparatus, said casing including a first case and a second case being locked together via a plurality of screws; said case coupling and reinforcing structure comprising a plurality of rib reinforcements perpendicularly spaced on an inner surface of said first case, and a plurality of cuts provided on said second case at positions corresponding to said rib reinforcements; whereby when said first case is assembled to said second case, said perpendicular rib reinforcements are tightly received in and engaged with said cuts to stably join said first case and said second case together.

2. The case coupling and reinforcing structure as claimed in claim 1, wherein said first case is an upper case and said case is a lower case of said electronic apparatus.

3. The case coupling and reinforcing structure as claimed in claim 1, wherein said first case is a lower case and said case is an upper case of said electronic apparatus.

4. The case coupling and reinforcing structure as claimed in claim 1, wherein said first and said second case are made of a plastic material.

5. The case coupling and reinforcing structure as claimed in claim 1, wherein said first and said second case are made of a light metal material.

6. The case coupling and reinforcing structure as claimed in claim 1, wherein said first case is further provided at predetermined positions with a plurality of screw sleeves, and said second case is further provided with a plurality of screw holes at positions corresponding to said screw sleeves; whereby when a plurality of screws are separately threaded through said screw holes into said screw sleeves, said second case is locked to said first case.

7. The case coupling and reinforcing structure as claimed in claim 1, wherein said perpendicular rib reinforcements are provided at an inner side of a peripheral edge of said first case.

8. The case coupling and reinforcing structure as claimed in claim 1, wherein said perpendicular rib reinforcements have a shape selected from the group consisting of a flat strip, a round column, a semicircular column, a triangular column, a square column, and other irregularly shaped columns.

9. The case coupling and reinforcing structure as claimed in claim 1, wherein said cuts are provided on a peripheral edge of said second case.

10. The case coupling and reinforcing structure as claimed in claim 1, wherein said perpendicular rib reinforcements and said cuts may be exchanged in their positions on said first and said second case.
